(19) United States
(12) Patent Application Publication
(10) Pub. No.: US 2015/0318124 A1
(43) Pub. Date: Nov. 5, 2015

(54) IMPROVED CIRCUIT BREAKER APPARATUS

(71) Applicant: ALSTOM Technology Ltd., Baden (CH)

(72) Inventors: Didier RODRIGUES, SERPAIZE (FR); Denis FRIGIERE, DECINES (FR); Jean-Marc WILLIEME, LA MULATIERE (FR); Frank JACQUIER, MIONS (FR)

(73) Assignee: ALSTOM Technology Ltd, BADEN (CH)

(21) Appl. No.: 14/650,049

(22) PCT Filed: Dec. 11, 2013
(86) PCT No.: PCT/EP2013/076252

§ 371 Date: Jun. 5, 2015

(30) Foreign Application Priority Data
Dec. 12, 2012 (FR) 12 61956

(51) Int. Cl. H01H 9/38; H01H 33/42; H01H 33/64

(52) U.S. Cl. CPC H01H 9/38; H01H 33/64; H01H 33/42

(57) ABSTRACT

A switchgear comprising a set of arcing contacts, a set of disconnection contacts, and a set of permanent contacts, a first branch including the set of arcing contacts and the set of disconnection contacts connected in series, a second branch including the set of permanent contacts, the second branch being connected in parallel with the first branch, including a first controller and a second controller, the first controller making it possible to cause the set of arcing contacts and of the set of permanent contacts, the second controller making it possible to cause the set of disconnection contacts change over between its two positions, said disconnection contacts being able to change over towards its open position only when the set of arcing contacts and the set of permanent contacts are in their open positions, the two controllers being separate, the second being a button connected to an electric motor.

### TECHNICAL FIELD

The invention relates to high-voltage electrical circuits. More particularly, the invention relates to improved switchgear.

### STATE OF THE PRIOR ART

High-voltage circuits may include, among others, two types of switchgear: circuit breakers and disconnectors.

A disconnector comprises a single set of contacts, called permanent contacts. The permanent contacts of a disconnector may be in air. When it is closed, the disconnector allows current to pass via the permanent contacts. When it is open, the permanent contacts of a disconnector are spaced apart by a distance that provides a determined dielectric strength.

A circuit breaker comprises both a set of main contacts, also called “permanent contacts”, and a set of arcing contacts. In known manner, these two sets of contacts are placed in a closed volume containing a gas suitable for electric arc extinction, and therefore interruption of the current. When it is closed, the circuit breaker allows current to pass via the permanent contacts. During its opening operation, the permanent contacts separate, followed by the arcing contacts.

A circuit breaker and a disconnector are generally used in series in order to combine the characteristics and advantages of each kind of equipment: the breaking power of the circuit breaker and the dielectric strength of the disconnector. Such a series architecture has two separate controllers: the circuit breaker controller and the disconnector controller.

FIG. 1 shows such a series connection of a circuit breaker 11 and of a disconnector 21. The circuit breaker 11 has a set of permanent contacts 12 and a set of arcing contacts 13. The disconnector 21 has a set of permanent contacts 22. In this example, all of the sets of contacts 12, 13, and 22 are shown in their open positions.

In such a connection, the current is caused to flow through two sets of permanent contacts, and that gives rise to considerable power losses caused by the Joule effect.

In addition, French patent application No. FR 2 763 171 is known and describes a combined breaker-disconnector circuit.

The equipment described by that document has a circuit breaker having a plurality of outer concentric tubes forming the main contacts, and arcing contacts inside the tubes. A disconnector is integrated in the circuit breaker, inside the tubes and aligned longitudinally with the arcing contacts.

That equipment has the particularity of having a mechanical controller in the form of a hub contained in a shaft. The shaft has a lever connected to a sliding tube of the circuit breaker. The hub has a lever connected to a rod forming a movable arcing contact. The hub further comprises a rod connected to a sliding contact of the disconnector.

Driving the shaft in rotation makes it possible to separate in succession: the main contacts of the circuit breaker; the arcing contacts; and finally the contacts of the disconnector.

That architecture presents the drawback of using a complex controller in order to move the various elements.

In addition, the whole set of elements is caused to move by a single controller, and that differs from the mode of operation of the conventional series connection of a circuit breaker and of a disconnector.

The invention aims to provide an alternative to existing combination breaker-disconnector circuits that is simple, offers great flexibility of use, and that is economical.

### SUMMARY OF THE INVENTION

The invention thus relates to switchgear comprising a set of arcing contacts, a set of disconnection contacts and a set of permanent contacts, a first branch including the set of arcing contacts, and the set of disconnection contacts connected in series, a second branch including the set of permanent contacts, the second branch being connected in parallel with the first branch, each set of contacts having a respective open position and a respective closed position. The switchgear of the invention includes a first controller and a second controller, the first controller allowing to simultaneously activate changing over of the set of arcing contacts and the set of permanent contacts from one position to the other, the second controller making it possible to cause the set of disconnection contacts to change over between its two positions, the set of disconnection contacts being able to change over towards its open position only when the set of arcing contacts and the set of permanent contacts are in their open positions, the two controllers being separate controllers, the second controller being an actuator button connected to an electric motor.

Thus, in the switchgear of the invention, when the circuit is closed, the current advantageously passes almost exclusively via a single set of contacts, i.e. the contacts of the second branch, which is why they are known as permanent contacts, thereby limiting Joule effect losses.

Operating the switchgear is easy, i.e. the presence of a separate command for the dielectric function enables independent and precise operation of disconnection contacts as opposed to French patent No. FR 2 763 171 in which the disconnector is actuated automatically as soon as breaking is complete.

According to an advantageous characteristic of the invention, the set of arcing contacts is isolated independently of the set of permanent contacts inside a gastight volume containing sulfur hexafluoride (SF₆).

Since this insulating gas has good insulating and arc absorption properties, the invention advantageously makes it possible to limit the volume of the arc-control chamber.

According to an advantageous characteristic of the invention, the set of permanent contacts is isolated independently of the set of arcing contacts and of the set of disconnection contacts.

The invention also provides a method of breaking a circuit by implementing switchgear comprising a set of arcing contacts, a set of disconnection contacts, and a set of permanent contacts, a first branch including the set of arcing contacts and the set of disconnection contacts connected in series, a second branch including the set of permanent contacts, the second branch being connected in parallel with the first branch, each set of contacts having a respective open position and a respective closed position, the switchgear further comprising a first controller and a second controller, the first controller allowing to simultaneously activate changing over of the set of arcing contacts and the set of permanent contacts from one position to the other, the second controller making it possible to cause the set of disconnection contacts to change over between its two positions, the method comprising the following steps:
the first controller acting during an opening command to cause the set of arcing contacts and the set of permanent contacts to change over towards their open positions; and
the second controller causing the disconnection contacts to provide dielectric separation, which contacts may be separated from each other only when the set of arcing contacts and the set of permanent contacts are found in their open positions, the two controllers being separate controllers, the second controller being an actuator button connected to an electric motor.

### BRIEF DESCRIPTION OF THE DRAWING

Embodiments of the invention are described below by way of non-limiting example, and with reference to the accompanying drawing, in which:

FIG. 1 is a diagram of known switchgear comprising a circuit breaker and a disconnector connected in series; and

FIG. 2 is a diagram of novel switchgear.

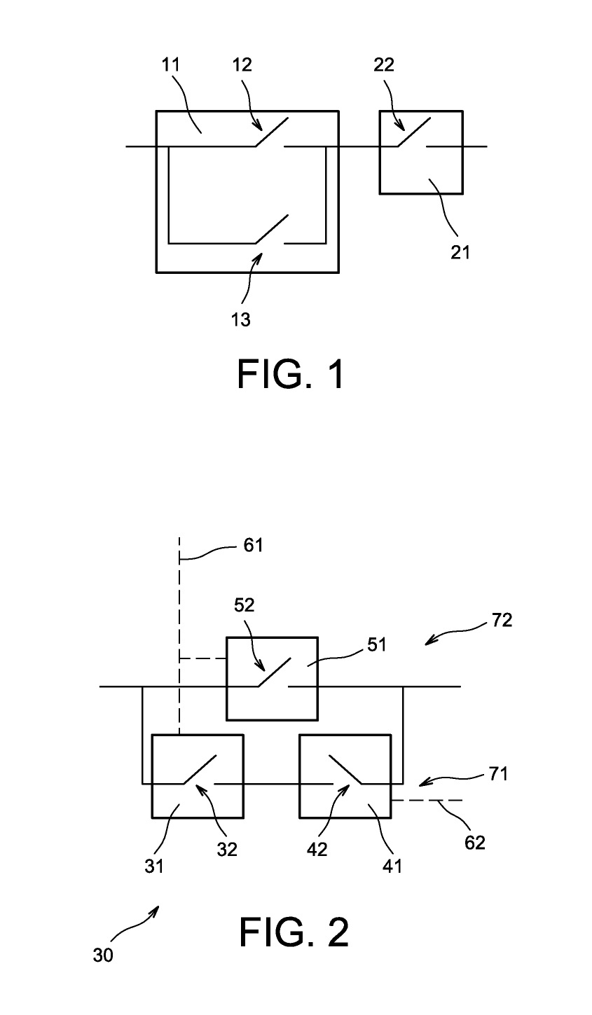

### DETAILED DESCRIPTION OF PARTICULAR EMBODIMENTS

The switchgear 30 for interrupting electric current presents a breaker module 31, and two dielectric separation modules 41 and 51.

The switchgear 30 further comprises two controllers 61 and 62.

The breaker module 31 comprises a set of arcing contacts 32. The breaker module 31 has a closed position in which current may flow therethrough and an open position in which the current is interrupted. The contacts 32 are configured to withstand the formation of an electric arc during separation (as well as when they move towards each other when current is restored), i.e. during an operation of transition between the closed position and the open position.

The set of arcing contacts 32 is insulated in a closed volume containing sulfur hexafluoride (SF₆) or some other gas or mixture of gases having the desired insulating properties, or even in a closed volume providing a vacuum, e.g. a vacuum circuit breaker.

The separation module 41 comprises a set of disconnection contacts 42. The set of disconnection contacts 42 has an open position and a closed position. In the open position, the contacts 42 provide a dielectric function, i.e. a function of electrical isolation due to their distance apart.

The contacts 42 are insulated inside a closed volume containing air, N2 or some other gas or mixture of gases having the desired insulating properties.

The separation module 51 comprises a set of disconnection contacts 52. The set of disconnection contacts 52 has an open position and a closed position. In the open position, the contacts 52 provide a dielectric function, i.e. a function of electrical isolation due to their distance apart.

The contacts 52 are insulated inside a closed volume containing sulfur hexafluoride (SF₆), air, N₂, or some other gas or mixture of gases having the desired insulating properties.

Since the module 41 is separated from the other modules, it is polluted neither by the arc-control gases, nor by the products generated by the arc.

The nature and pressure of the gas are adapted to each module.

The breaker module 31 and the separation module 41 are connected in series with each other, thus forming part of a first branch 71.

A second branch 72, of which the separation module 51 forms part, is connected in parallel with the first branch 71. The separation module 51 is connected at a first end of the first branch 71 to the breaker module 31 and at a second end of the first branch 71 to the separation module 41.

The first controller 61 controls the breaker module 31 and the separation module 51 to open simultaneously.

The second controller 62 controls the separation module 41 to open. In this embodiment, the controller 62 constitutes means for actuating an electric motor, e.g. an actuator button connected to an electric motor.

These two controllers 61 and 62 are mechanically and/or electrically interlocked while being separate, that is to say their openings are controlled independently of the other. Interlocking is for example achieved by electric logic. I.e. the transmission of opening or closing commands depends on the closed or open states of the various modules.

In the example, the controller 62 is able to open the separation module 41 only when the modules 31 and 51 are in the open position. Conversely, the controller 61 can be actuated to close only when the set of contacts 42 is in the closed position.

When the switchgear is in the closed state, i.e. when current flows therethrough, the modules 31, 41, and 51 are all in the closed position.

The dimensioning of the switchgear is such that the electrical resistance of the branch 71 is greater than the resistance of the branch 72 by a factor of at least 10. In addition, due to skin effect, the current density is smaller by a factor of at least 100 in the branch 71. Thus, the Joule effect losses in the branch 71 are much lower and negligible relative to those in the branch 72. The contacts 52 are therefore said to be permanent contacts.

The steps of breaking a circuit are described below.

The controller 61 activates the breaker module 31 and the separation module 51 to open.

The architecture of the switchgear 30 is such that the contacts 52 separate before the arcing contacts 32. When the contacts 52 are separated, the current no longer flows in the second branch 72.

When the arcing contacts 32 separate, an electric arc is formed. On extinguishing the arc, the current is interrupted in both branches 71 and 72.

The separation module 41, is then opened, i.e. the contacts 42 are separated by actuating the second controller 62, in such a manner as to prevent current from being re-established in the branch 71 during intervention on a deactivated portion of circuit.

Finally, the steps of closing the switchgear in order to re-establish the current are described below.

The set of contacts 42 is closed before the sets of contacts 32 and 52.

The controller 62 is actuated in such a manner as to close the separation module 41, and then the controller 61 is actuated to close the breaker module 31 and the separation module 51.

On closing, the arcing contacts 32 join together before the contacts 52. When the arcing contacts 32 move closer to each other, an electric arc is created and persists until the contacts join together. The contacts 52 then come into contact and current is re-established.

1. Switchgear comprising a set of arcing contacts, a set of disconnection contacts, and a set of permanent contacts, a first branch including the set of arcing contacts and the set of disconnection contacts connected in series, a second branch including the set of permanent contacts, the second branch being connected in parallel with the first branch, each set of contacts having a respective open position and a respective closed position, the switchgear being characterized in that it includes a first controller and a second controller, the first controller allowing to simultaneously activate changing over of the set of arcing contacts and the set of permanent contacts from one position to the other, the second controller making it possible to cause the set of disconnection contacts to change over between its two positions, the set of disconnection contacts being able to change over towards its open position only when the set of arcing contacts and the set of permanent contacts are in their open positions, the two controllers being separate controllers, the second controller being an actuator button connected to an electric motor.

2. Switchgear according to claim 1 wherein the set of arcing contacts is isolated independently of the set of permanent contacts inside a gastight volume containing sulfur hexafluoride.

3. Switchgear according to claim 1 wherein the set of permanent contacts is isolated independently of the set of arcing contacts and of the set of disconnection contacts.

4. A method of breaking a circuit by implementing switchgear comprising a set of arcing contacts, a set of disconnection contacts, and a set of permanent contacts, a first branch including the set of arcing contacts and the set of disconnection contacts connected in series, a second branch including the set of permanent contacts, the second branch being connected in parallel with the first branch, each set of contacts having a respective open position and a respective closed position, the switchgear including a first controller and a second controller, the first controller allowing to simultaneously activate changing over of the set of arcing contacts and the set of permanent contacts from one position to the other, the second controller) making it possible to cause the set of disconnection contacts change over between its two positions, the method comprising the following steps:
the first controller acting during an opening command to cause the set of arcing contacts and the set of permanent contacts to change over towards their open positions; and
the second controller causing the disconnection contacts to provide dielectric separation, which contacts may be separated from each other only when the set of arcing contacts and the set of permanent contacts are found in their open positions, the two controllers being separate controllers, the second controller) being an actuator button connected to an electric motor.
